(19) United States
(12) Patent Application Publication
(10) Pub. No.: US 2005/0053085 A1
(43) Pub. Date: Mar. 10, 2005

(54) Apparatus and method for controlling upstream traffic for use in ethernet passive optical network

(76) Inventors: Sang-Hyun Doh, Hwaseong-si (KR); Young-Seok Kim, Seongnam-si (KR); Yun-Je Oh, Yongin-si (KR)

Correspondence Address: CHA & REITER, LLC, 210 ROUTE 4 EAST STE 103, PARAMUS, NJ, 07652, US

(21) Appl. No.: 10/864,017

(22) Filed: Jun. 9, 2004

(30) Foreign Application Priority Data
Sep. 4, 2003 (KR) 2003-61900

(51) Int. Cl. H04L 12/28; H04L 12/413

(52) U.S. Cl. 370/431; 370/445

(57) ABSTRACT

Apparatus and method for controlling upstream traffic for use in EPON (Ethernet Passive Optical Network) system. The method for controlling upstream data traffic transferred from an ONU (Optical Network Unit) to an OLT (Optical Line Termination) in an EPON (Ethernet Passive Optical Network) system including an ODN (Optical Distribution Network) connected to one OLT, and a plurality of ONUs connected to the ODN and also respectively connected to a plurality of subscribers, includes the steps of a) controlling the OLT to determine an ONU serving as an upstream transmission authority allocation target; b) controlling the OLT to insert information of a predetermined ONU serving as an upstream transmission authority allocation target ONU in a downstream data frame transferred to the ONU, and transmitting the downstream data frame having the inserted ONU information; and, c) controlling the upstream transmission authority allocation target ONU having received the downstream data frame to transmit upstream data. Therefore, limited traffic resources can be used equally by a plurality of ONUs, resulting in the prevention of data collision among upstream signals.

### CLAIM OF PRIORITY

This application claims priority to an application entitled “APPARATUS AND METHOD FOR CONTROLLING UPSTREAM TRAFFIC FOR USE IN ETHERNET PASSIVE OPTICAL NETWORK,” filed in the Korean Intellectual Property Office on Sep. 4, 2003 and assigned Serial No. 2003-61900, the contents of which are hereby incorporated by reference.

### BACKGROUND OF THE INVENTION

1. Field of the Invention

The present invention relates to a PON (Passive Optical Network) system, and more particularly, to an apparatus and method for controlling upstream traffic for use in an EPON (Ethernet Passive Optical Network) system.

2. Description of the Related Art

A variety of network configurations and improved methods-for example, an xDSL (x-Digital Subscriber Line), an HFC (Hybrid Fiber Coax), an FTTB (Fiber To The Building), an FTTC (Fiber To The Curb), and an FTTH (Fiber To The Home), etc.—have been proposed to configure a subscriber network (or an optical network) ranging from a telephone office to individual buildings or households. In particular, the FTTx (where x=B, C, and H) is classified into an active FTTx defined by an AON (Active Optical Network) system and a passive FTTx defined by a PON (Passive Optical Network) system.

The PON system for constructing the passive FTTx has a network configuration in the form of a point-to-multipoint topology configured by passive elements, which in turn improves the method of constructing a cost-effective optical network. The PON system connects one OLT (Optical Line Termination) to a plurality of ONUs (Optical Network Units) via a 1xN ODN (Optical Distribution Network), resulting in a tree-structured distribution topology. One known representative PON system is an ATM-PON (Asynchronous Transfer Mode Passive Optical Network) system, which has been standardized in an ITU-T G.982, an ITU-T G.983.1, and an ITU-T G.983.3 recommended by an ITU-T ((International Telecommunication Union-Telecommunication section). Standardization of a GE-PON (Gigabit Ethernet-Passive Optical Network) system is in progress by the IEEE (Institute of Electrical and Electronics Engineers) under the IEEE 802.3ah TF.

The point-to-point GE (Gigabit Ethernet) technology and ATM-PON MAC (Medium Access Control) technology already have been standardized, and their related techniques are prescribed in the IEEE 802.3z and ITU-T G.983.18. A representative example of the ATM-PON MAC technology is described in U.S. Pat. No. 5,978,374 issued on 2 Nov. 1999, entitled “PROTOCOL FOR DATA COMMUNICATION OVER A POINT-TO-MULTIPOINT PASSIVE OPTICAL NETWORK,” which is incorporated herein by reference.

FIG. 1 is a block diagram of a conventional PON system. The PON system includes one OLT 10, an ODN 16, and a plurality of ONUs 12a˜12c, and the OLT 10 is connected to the ONUs 12a˜12c via an ODN 16. As shown, the OLT 10 is located on a tree structure route and plays an important role in providing information to each subscriber in an access network. The ODN 16 is connected to the OLT 10 and has a tree-structured topology.

In operation, the ODN 16 distributes downstream data frames received from the OLT 10 to the ONUs 12a˜12c, or multiplexes upstream data frames received from the ONUs 12a˜12c for subsequent transmission to the OLT 10. The ONUs 12a˜12c is operative to receive downstream data frames and transmits them to a plurality of end users 14a˜14c, and further transmits data received from the end users 14a˜14c, i.e., upstream data frames from the end users 14a˜14c, to the OLT 20 via the ODN 16. In this case, the end users 14a˜14c connected to the respective ONUs 12a˜12c designate a variety of subscriber-network termination units available for the PON system containing an NT (Network Terminal). An Ethernet-based PON system contained in this type of PON systems is generally known as an EPON (Ethernet Passive Optical Network).

According to the EPON system shown in FIG. 1, downstream data transferred from the OLT 10 to the ONUs 12 is broadcast by the ODN 16, and is then transmitted to all the ONUs 12. Thereafter, individual ONUs 12 extract their corresponding signals from the received data and receive the extracted signals. Therefore, there is no problem for one OLT 10 to access the ONUs 12 in downstream traffic. However, in case of upstream traffic, data collision may occur among signals when more than one ONU 12 attempts to access the OLT 10.

To address the above problem, the EPON system typically adapts a TDM (Time Division Multiplexing)-based upstream traffic control method to resolve the data collision problem. The TDM-based control method equally assigns a predetermined period of time to individual ONUs, and transmits upstream signals to the ONUs within only the assigned predetermined period of time, thus resulting in the prevention of signal collision among the ONUs. However, when there is no upstream transmission during the assigned time period, the system's efficiency suffers.

In order to improve the efficiency, there has been an improved method that does away with assigning a fixed time period to the individual ONUs for signal transmission, by controlling the ONU to inform the OLT of an upstream signal to be transferred by the ONU and requesting a bandwidth needed for the transmission. However, if an ONU is excluded from the bandwidth allocation process for transmitting an upstream signal, this ONU is continuously excluded from the bandwidth allocation process. Further, an undesirably lengthy time period must elapse for the completion of an upstream transmission even though new data traffic occurs, resulting in unnecessary additional time delay. Furthermore, this method creates irregular upstream traffic, thus creating a frequent bandwidth request signal which in turn deteriorates the efficiency of the entire system.

### SUMMARY OF THE INVENTION

Therefore, the present invention has been made in view of the above problems and provides additional advantages, by providing an apparatus and method for controlling an upstream traffic to prevent the upstream signals from colliding with each other in an EPON system.

One aspect of the present invention is to provide an apparatus and method for controlling upstream traffic to improve the efficiency of the EPON system.

Another aspect of the present invention is to provide an apparatus and method for controlling upstream traffic so that either one of the ONUs is prevented from completely occupying the data traffic resources, thus improving the system impartiality.

Another aspect of the present invention is to provide an apparatus and method for controlling upstream traffic, so that either one of the ONUs is prevented from being excluded from the data traffic resources in the EPON system.

It is yet another aspect of the present invention to provide an apparatus and method for controlling upstream traffic to provide individual ONUs with unique differentiated services.

In one embodiment, a method is provided for controlling upstream data traffic transferred from an ONU (Optical Network Unit) to an OLT (Optical Line Termination) in an EPON (Ethernet Passive Optical Network) system of the type having an ODN (Optical Distribution Network) connected to one OLT, and a plurality of ONUs connected to the ODN and to a plurality of subscribers. The method includes the steps of: a) sequentially determining an upstream transmission, authority allocation sequence of ONUs connected to the OLT; b) initializing upstream traffic use efficiency of the ONUs; c) upon receiving the upstream transmission, the authority allocation sequence of the ONUs and the upstream traffic use efficiency of the ONUs, determining the ONU serving as an upstream transmission authority allocation target; d) storing information of the ONU that has been determined as the upstream transmission and the authority allocation target in a downstream data frame to be transferred from the OLT to the ONU; e) broadcasting the downstream data frame containing the information of the ONU that has been determined as the upstream transmission authority allocation target; and f) receiving upstream data from a predetermined ONU, and updating the upstream traffic use efficiency of a corresponding ONU.

In another embodiment, an apparatus is provided for controlling upstream data traffic transferred from an ONU (Optical Network Unit) to an OLT (Optical Line Termination) in an EPON (Ethernet Passive Optical Network) system of the type having an ODN (Optical Distribution Network) connected to one OLT, and a plurality of ONUs connected to the ODN and a plurality of subscribers. The apparatus includes: a traffic manager for managing the upstream data traffic information transferred from the ONU to the OLT; a controller for determining the ONU serving as an upstream transmission, authority allocation target on the basis of the upstream data traffic information managed by the traffic manager; a downstream data processor for inserting information of the ONU that has been determined by the controller in a downstream data frame to be transferred from the OLT to the ONU; and a transmitter for broadcasting the downstream data frame having been created by the downstream data processor to the ONUs.

### BRIEF DESCRIPTION OF THE DRAWINGS

The above features and other advantages of the present invention will be more clearly understood from the following detailed description taken in conjunction with the accompanying drawings, in which:

FIG. 1 is a block diagram of a conventional PON system;

FIG. 2 is a block diagram of an upstream traffic control apparatus in accordance with a preferred embodiment of the present invention;

FIGS. 3a˜3b are flow charts illustrating an upstream traffic-=control method in accordance with a preferred embodiment of the present invention; and,

FIG. 4 is a flow chart illustrating a process for controlling ONUs to transfer upstream data using the upstream traffic control method in accordance with a preferred embodiment of the present invention.

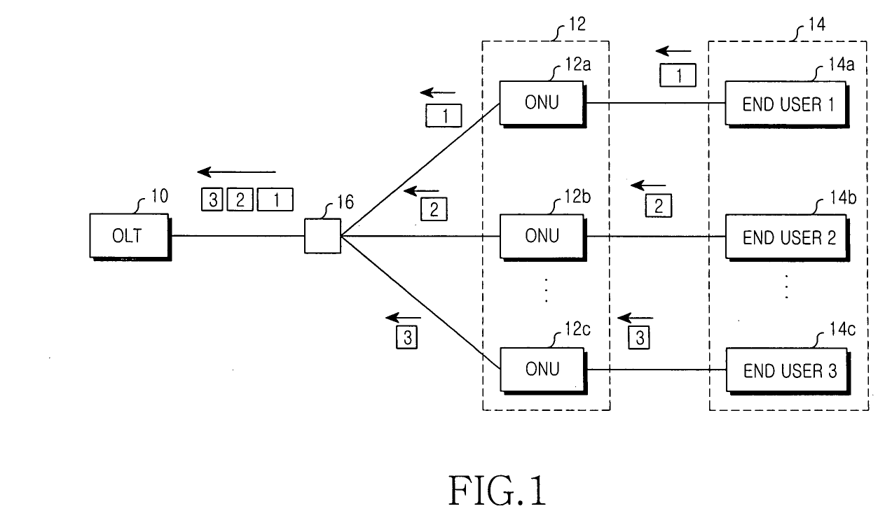

### DETAILED DESCRIPTION OF THE INVENTION

Now, embodiments of the present invention will be described in detail with reference to the annexed drawings. In the drawings, the same or similar elements are denoted by the same reference numerals even though they are depicted in different drawings. For the purposes of clarity and simplicity, a detailed description of known functions and configurations incorporated herein will be omitted as it may make the subject matter of the present invention unclear.

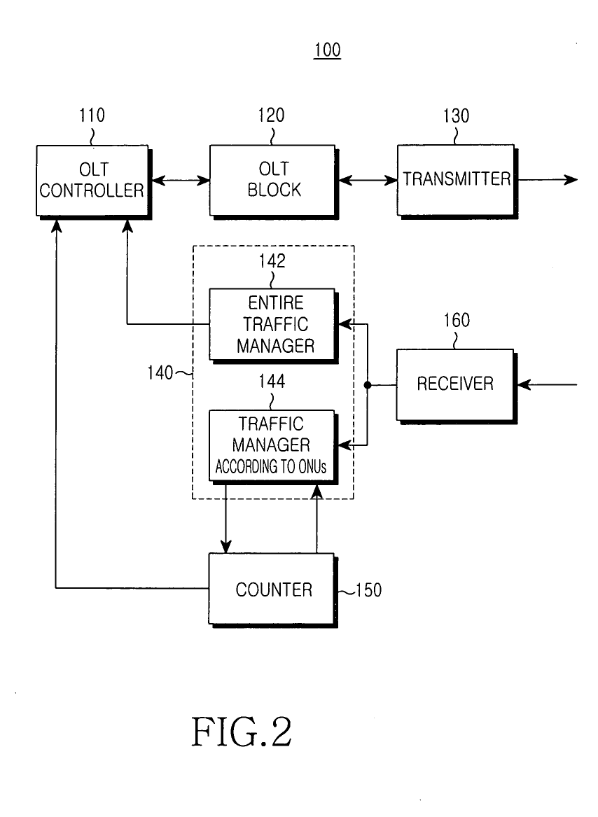

FIG. 2 is a block diagram of an upstream traffic control apparatus 100 in accordance with a preferred embodiment of the present invention. As shown in FIG. 2, the upstream traffic control apparatus includes an OLT controller 110, an OLT block 120, a transmitter 130, a traffic manager 140, a counter 150, and a receiver 160.

According to the teachings of the present invention, the upstream traffic control apparatus 100 inserts upstream transmission authority allocation information in a downstream data frame. In more detail, the upstream traffic control apparatus 100 inserts information relating to an ONU serving as a “next upstream transmission authority allocation target” in a predetermined field of the downstream data frame (for example, a designation field of an ONU serving as an upstream transmission authority allocation target, which indicates the ability to transmit upstream data). This information is sent via the downstream data frame to ONUs connected to the OLT.

Meanwhile, the ONU stores generated upstream data in an internal buffer. If a downstream transmission frame transmitted from the OLT is received, the ONU stores the received downstream transmission frame therein. At this time, when an ONU receives the downstream data frame and this ONU is prescribed in the ONU designation field of an upstream transmission authority allocation target, the ONU then performs upstream transmission of the pre-stored upstream data stored in the internal buffer.

Now, individual components of the upstream traffic control apparatus 100 for the upstream transmission will be hereinafter described with reference to FIG. 2.

Referring to FIG. 2, the transmitter 130 transmits downstream data to a plurality of subscribers, and the receiver 160 receives upstream data from the subscribers to an ONU.

The traffic manager 140 manages the upstream data traffic received from the receiver 160. Particularly, the traffic manager 140 separately manages the entire upstream data traffic received from all the subscribers and upstream data traffic directed to each ONU. To achieve this, the traffic manager 140 includes an entire traffic manager 142 for managing the entire upstream data traffic and individual traffic managers 144 for managing the respective upstream data traffic of the ONUs. The number of individual traffic managers 144 is equal to the number of ONUs connected to an OLT, thus enabling the management of upstream data traffic for each ONU connected to the OLT.

The counter 150 determines whether a new ONU is connected to the OLT during an interval of a predetermined time period. In more detail, the counter 150 analyzes the upstream data received from the ONU for every predetermined time period to determine whether a new ONU is connected to the OLT.

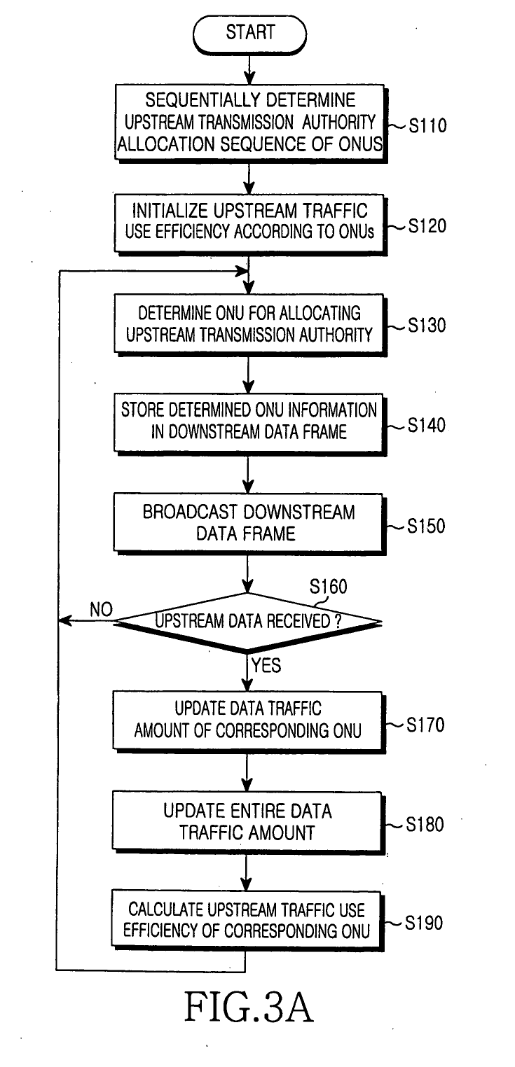

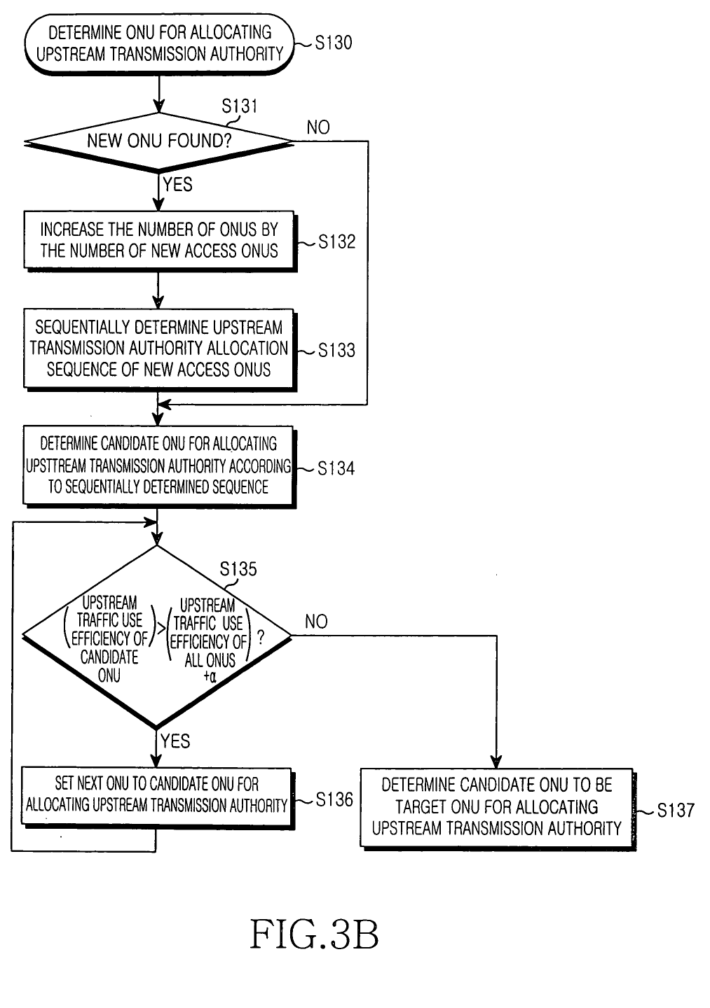

The OLT controller 110 receives traffic information of upstream data from the traffic manager 140, and based on this information, the OLT controller 110 determines an ONU that will be assigned as the upstream transmission authority allocation target. The OLT controller 110 determines an ONU that will be assigned as an upstream transmission authority allocation target using upstream traffic-use efficiency, as explained later in detail with reference to FIG. 3. Then, the OLT block 120 generates and transmits downstream data including the ONU information, via the transmitter 130, to the entire ONUs. That is, the OLT block 120 controls the downstream data to be transferred from a backbone network to a plurality of subscribers. Upon receiving downstream data, the OLT block 120 inserts information of a specific ONU in a downstream data frame, and transmits the downstream data frame to the transmitter 130. Thus, a particular ONU determined by the OLT controller 110 based on the traffic information received from the traffic manager 140 selects an ONU to allow transmission of upstream data. The ONU determined by the OLT controller 110 is now authorized to transmit during upstream transmission when the ONU receives downstream data with its own ONU information specified as the upstream transmission authority allocation target.

FIGS. 3a˜3b are flow charts illustrating an upstream traffic control method in more details in accordance with an embodiment of the present invention.

Referring to FIGS. 2 and 3a, the OLT controller 110 determines upstream transmission authority allocation sequences of individual ONUs at step S110. Here, the sequences of ONUs connected to the OLT 10 to be named as the next upstream transmission authority target are determined. Note that the upstream transmission authority allocation sequences determined at step S110 may be changed according to the traffic condition of the individual ONUs reported by the traffic manager 140.

If the upstream transmission authorities for every ONU coupled to the OLT 10 are allocated at step S110, the OLT controller 110 initializes upstream traffic use efficiency according to the amount of the entire upstream traffic and the upstream traffic from each ONU at step S120. That is, the upstream traffic use efficiency is determined by comparing the amount of upstream traffic of each ONU provided by the individual traffic manager 144 to the entire upstream traffic provided by the entire traffic manager 142. Accordingly, upstream traffic use efficiency of all the ONUs connected to the OLT is initialized at step S120. Note that the upstream traffic use efficiency for every ONU is updated continuously depending on the upstream traffic information from a network.

Therefore, the OLT controller 110 determines an ONU that will be assigned as an upstream transmission authority allocation target with reference to the upstream traffic use efficiency at step S130. In more detail, the OLT controller 110 determines a specific ONU serving as an upstream transmission authority allocation candidate on the basis of the upstream transmission authority allocation sequence determined at step S110 by determining whether the upstream traffic use efficiency of the ONUs determined in step S110 is higher than the average upstream traffic use efficiency of all ONUs by a predetermined value α. If it is lower, the OLT controller 110 allocates the upstream transmission authority to the ONU. If it is higher, the next ONU determined in step S110 is selected as an upstream transmission authority allocation candidate. These steps are repeated, such that it can prevent limited traffic resources from being monopolized by a specific ONU. As a result, the limited traffic resources can be used uniformly by a plurality of ONUs.

It should be noted that the upstream traffic use efficiency of all ONUs is set to an initial value (e.g., “0”) in the initial step. Therefore, the ONU having been initially determined at step S110 is determined to be an ONU serving as an upstream transmission authority allocation target at step S130. When the ONU serving as the upstream transmission authority allocation target is determined at step S130, the OLT controller 110 transmits information of the determined ONU to the OLT block 120. The OLT block 120 stores information of the ONU serving as the upstream transmission authority allocation target in a downstream data frame received from a backbone network at step S140. In more detail, the OLT block 120 stores information of the ONU serving as the upstream transmission authority allocation target in a specific field of the downstream data frame (for example, a designation field of the ONU serving as an upstream transmission authority allocation target), and then transmits the downstream data frame to the transmitter 130.

The transmitter 130 transmits the downstream data frame containing the information of an ONU serving as the upstream transmission authority allocation target at step S150. In this case, the transmitter 130 transmits the downstream data frame to the ONUs using a broadcasting method.

If the receiver 160 receives upstream data at step S160, the traffic manager 140 identifies an ONU that transmitted the upstream data and updates the amount of data traffic of a corresponding ONU (for example, the amount of used upstream traffic) at step S170. In other words, the traffic manager 140 selects one ONU traffic manager 144 managing the amount of traffic of the ONU that has transmitted the upstream data from among a plurality of individual traffic managers 144, and then updates the amount of used upstream traffic stored in the selected ONU traffic manager 144.

The traffic manager 140 updates the amount of the entire data traffic (for example, the amount of used upstream traffic) at step S180. That is, the traffic manager 140 updates the amount of used upstream traffic stored in the entire traffic manager 142.

If the amount of data traffic for every ONU (for example, the amount of used upstream traffic for every ONU) and the amount of the entire data traffic (for example, the amount of the entire used upstream traffic) are updated at steps S170 and S180, the OLT controller 110 receives the updated amount of data traffic for every ONU (i.e., the amount of used upstream traffic for every ONU) and the updated amount of the entire data traffic (i.e., the amount of the entire used upstream traffic) from the traffic manager 140, and then calculates the upstream traffic use efficiency of a corresponding ONU at step S190.

The method for calculating upstream traffic use efficiency R_{UP}_{_{—}}_{TRAFFIC} of the ONU at step S190 is denoted by the following Equation 1:

$${R}_{UP} = \frac{{ONU}_{UPTRAFFIC}}{{TOTAL}_{UPTRAFFIC}} \qquad [ Equation 1 ]$$

Accordingly, the specific ONU serving as an upstream transmission authority allocation target is determined at step S130 by referring to the upstream traffic use efficiency having been calculated at step S190.

If the receiver 160 does not receive the upstream data at step S160, the OLT controller 110 returns to step S130 such that another ONU serving as the next upstream transmission authority allocation target is determined at step S130.

FIG. 3b is a flow chart illustrating a detailed procedure of the step S130 for determining a specific ONU serving as an upstream transmission authority allocation target in accordance with the embodiment of the present invention.

Referring to FIG. 3b, according to the above step S130 for determining the ONU serving as an upstream transmission authority allocation target, if newly-accessed ONUs are found, the OLT controller 110 assigns sequential orders to the newly-accessed ONUs, and determines an ONU serving as an upstream transmission authority allocation target by referring to upstream traffic use information of the above new ONUs and previous ONUs.

For this purpose, the OLT controller 110 determines whether either one of the newly-accessed ONUs is found at step S131. If either one of the newly-accessed ONUs is found at step S131, the OLT controller 110 increases the number of operable ONUs by the number of the newly-accessed ONUs at step S132, and sequentially determines upstream transmission authority allocation sequences of the newly-accessed ONUs at step S133. That is, the newly-accessed ONUs are assigned a sequence next to the last ONU from among a plurality of ONUs having been previously accessed. Then, the OLT controller 110 determines a specific ONU serving as an upstream transmission authority allocation candidate according to the above sequentially-determined order at step S134, and determines whether the upstream transmission authority may be allocated to the candidate ONU according to the upstream traffic use efficiency of the ONU at step S135.

In more detail, if the upstream traffic use efficiency of the ONU serving as the upstream transmission authority allocation candidate is higher than the average upstream traffic use efficiency of all ONUs by a predetermined value at step S135, the OLT controller 110 abandons the current candidate ONU, re-determines another ONU next to the current candidate ONU to a new upstream transmission authority allocation candidate according to the sequentially-determined order at step S136, and then repeats the above step S135.

Otherwise, if the upstream traffic use efficiency of the ONU serving as the upstream transmission authority allocation candidate is lower than the average upstream traffic use efficiency of all ONUs by the predetermined value at step S135, the OLT controller 110 finally determines the current candidate ONU to be a target ONU for allocating an upstream transmission authority at step S137.

Besides the aforementioned method, a token scheme may also be adapted to determine whether the upstream transmission authority is allocated to the above ONU having been selected as a candidate ONU at step S135. In particular, a predetermined token is calculated using the upstream traffic use efficiency of individual ONUs. If the calculated token is assigned “0”, the OLT controller 110 allocates the upstream transmission authority to a corresponding ONU. Otherwise, if the calculated token is assigned “1”, the OLT controller 110 disuses a corresponding ONU, and re-determines another ONU next to the corresponding ONU to be a candidate ONU.

The method for calculating a predetermined token using the upstream traffic use efficiency of the ONUs is denoted by the following Equation 2:

$$No\_skip \_token ( n , t ) = k ( n ) \frac{tra ( n , t ) - ( {tra}_{avg} ( N ( t ) , t ) + {tra}_{qua} )}{{tra}_{avg} ( N ( t ) , t )} \qquad [ Equation 2 ]$$

where, “n” is an arbitrary ONU, “nₒ” is the number of all ONUs connected to the OLT; “N(t)” is the number of activated ONUs connected to the OLT; “tra(n,t)” indicates upstream data traffic (e.g., a bit rate) received from a specific ONU; “tra_{avg} (N(t),t)” is the sum of the amount of all the traffic received from the OLT; “tra_{qua}” is the amount of minimum data traffic guaranteed by a corresponding EPON system during a predetermined period of time Δt.

A method for calculating “tra_{avg} (N(t),t)” is denoted by the following Equation 3:

$${tra}_{avg} ( N ( t ) , t ) = \frac{{\sum }_{n = 1}^{{n}_{0}} {\int }_{- t - Λ t}^{t} tra ( n , t ) ⅆ t}{N ( t )} \qquad [ Equation 3 ]$$

“No_skip_token” shown in Equation 2 means a function associated with the amount of average traffic received in the OLT during a predetermined time Δt and the amount of upstream transmission data traffic of a specific ONU during the predetermined time Δt. Provided that the specific ONU uses an average transmission quantity of a corresponding EPON system during the predetermined time Δt, “No_skip_token” is assigned “0”, such that the function of “No_skip_token” can be normally processed even though a current sequence reaches the next transmission authority sequence. However, provided that the specific ONU transmits the data amount of almost double the amount of the average traffic, “No_skip_token” is assigned “1”, such that this specific ONU is once excluded from the next transmission authority acquisition sequence. For example, the specific ONU once skips over the transmission authority acquisition sequence, and “No_skip_token” is assigned “1”. In this case, “No_skip_token” values for every ONU are continuously summed up. Whenever a positive integer occurs, a corresponding ONU associated with the positive integer is excluded from a specific scheme having transmission authority.

In this way, the ONUs can transmit the large amount of transmission data at once, and a specific ONU having employed the small amount of transmission data can acquire more data transmission opportunities. Data transmission authority can be more frequently assigned to the EPON system, resulting in increased efficiency in the entire system.

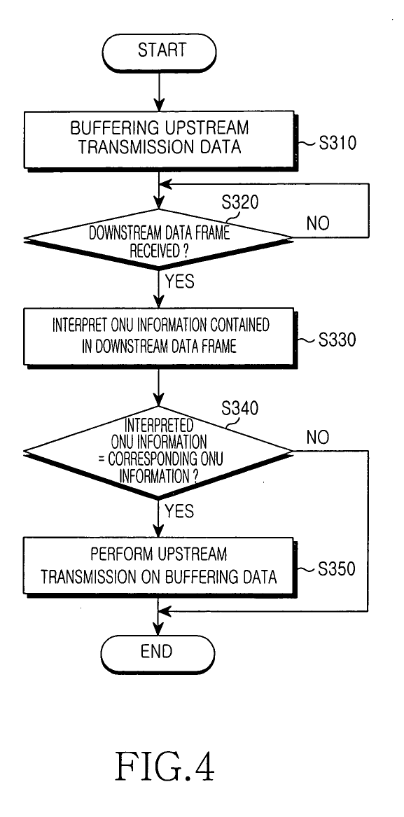

FIG. 4 is a flow chart illustrating a process for controlling ONUs to transfer upstream data using the upstream traffic control method in accordance with the embodiment of the present invention.

Referring to FIG. 4, individual ONUs perform buffering on an internal buffer whenever data to be an upstream transmission target occurs at step S310. Upon receiving a downstream data frame from the OLT at step S320, the ONUs interpret the ONU information contained in the received downstream data frame at step S330.

The ONUs having interpreted the received downstream data frame compare the ONU information having been interpreted at step 330 with the corresponding ONU information at step S340. If the interpreted ONU information is equal to that corresponding ONU information, the ONUs perform upstream transmission on the buffering data having been created at step S310 and at step S350.

As apparent from the above description, an upstream traffic control apparatus according to the present invention allocates an upstream transmission authority sequence to individual ONUs according to upstream traffic use information for every ONU, and thereby prevents either one of the ONUs from completely occupying a limited data traffic resource. And, the upstream traffic control apparatus prevents either one of the ONUs from being excluded from data traffic transmission resources, such that limited traffic resources can be equally used by a plurality of ONUs. Furthermore, the upstream traffic control apparatus allows only an ONU having an upstream transmission authority sequence to perform upstream transmission, resulting in the prevention of data collision among upstream signals. Therefore, the upstream traffic control apparatus can improve efficiency of the EPON system.

Although the preferred embodiments of the present invention have been disclosed for illustrative purposes, those skilled in the art will appreciate that various modifications, additions, and substitutions are possible without departing from the scope and spirit of the invention as disclosed in the accompanying claims.

1. A method for controlling upstream data traffic transferred from an ONU (Optical Network Unit) to an OLT (Optical Line Termination) in an EPON (Ethernet Passive Optical Network) system, which includes an ODN (Optical Distribution Network) coupled to the OLT, and a plurality of ONUs coupled to the ODN and a plurality of subscribers, the method comprising the steps of:
a) determining an ONU to allocate an upstream transmission authority based on the upstream traffic use efficiency of the respective ONUs;
b) controlling the OLT to insert information of a predetermined ONU serving as an upstream transmission authority allocation target ONU in a downstream data frame transferred to the ONU, and transmitting the downstream data frame having the inserted ONU information; and,
c) controlling the upstream transmission authority allocation target ONU having received the downstream data frame to transmit upstream data according to a predetermined condition.

2. The method as set forth in claim 1, further comprising the step of:
d) receiving the upstream data from a predetermined ONU, calculating the upstream traffic use efficiency of a corresponding ONU, and storing and managing the calculated upstream traffic use efficiency.

3. The method as set forth in claim 1, wherein the ONU determination step (a) includes the steps of:
a1) determining an upstream transmission authority allocation sequence of ONUs coupled to the OLT;
a2) upon receiving the upstream transmission authority allocation sequence, determining a candidate ONU by comparing an upstream traffic use efficiency of the candidate ONU with an average upstream traffic use efficiency of all ONUs; and,
a3) upon receiving the result of the comparison, if the upstream traffic use efficiency of the candidate ONU is lower than the average upstream traffic use efficiency of all ONUs by a predetermined value, determining the candidate ONU to be the upstream transmission authority allocation target ONU.

4. The method as set forth in claim 3, wherein the ONU determination step (a) further includes the step of:
a5) if the upstream traffic use efficiency of the candidate ONU is higher than the average upstream traffic use efficiency of all ONUs by a predetermined value, changing the candidate ONU to the next ONU according to the upstream transmission authority allocation sequence determined at step (a1), and repeating the comparison step (a2).

5. The method as set forth in claim 3, wherein the upstream transmission authority allocation sequence determination step (a1) includes the steps of:
a1-1) determining whether a new ONU accessing the OLT is found during a predetermined search time; and,
a1-2) if the new ONU accessing the OLT has been found, adding the new ONU to the upstream transmission authority allocation sequence.

6. The method as set forth in claim 1, wherein the transmission of upstream data is performed if the ONU having the upstream data for transmission receives the downstream data frame designating the ONU as the upstream transmission authority allocation target ONU.

7. A method for controlling the upstream data traffic transferred from an ONU (Optical Network Unit) to an OLT (Optical Line Termination) in an EPON (Ethernet Passive Optical Network) system including an ODN (Optical Distribution Network) connected to one OLT, and a plurality of ONUs connected to the ODN and also respectively coupled to a plurality of subscribers, the method comprising the steps of:
a) determining an upstream transmission authority allocation sequence of ONUs coupled to the OLT;
b) initializing upstream traffic use efficiency of the ONUs;
c) upon receiving the upstream transmission authority allocation sequence of the ONUs and the upstream traffic use efficiency of the ONUs, determining an ONU serving as an upstream transmission authority allocation target ONU;
d) storing information of the ONU having been determined as the upstream transmission authority allocation target in a downstream data frame to be transferred from the OLT to the ONU;
e) broadcasting the downstream data frame containing the information of the ONU having been determined as the upstream transmission authority allocation target; and,
f) receiving upstream data from a predetermined ONU, and updating the upstream traffic use efficiency of a corresponding ONU.

8. The method as set forth in claim 7, wherein the ONU determination step (c) includes the steps of:
c1) determining a candidate ONU for upstream transmission authority allocation according to the upstream transmission authority allocation sequence determined at step (a);
c2) comparing upstream traffic use efficiency of the candidate ONU with an average upstream traffic use efficiency of all ONUs; and,
c3) upon receiving the result of the comparison, if the upstream traffic use efficiency of the candidate ONU is lower than the average upstream traffic use efficiency of all ONUs by a predetermined value, determining the candidate ONU to be the upstream transmission authority allocation target ONU.

9. The method as set forth in claim 8, wherein the ONU determination step (c) further includes the step of:
c4) if the upstream traffic use efficiency of the candidate ONU is higher than the average upstream traffic use efficiency of all ONUs by a predetermined value, selecting a new candidate ONU according to the upstream transmission authority allocation sequence determined in step (a1), and repeating the comparison step (a3).

10. The method as set forth in claim 8, wherein the step (c3) for determining the upstream transmission authority allocation target ONU includes the step of:
if a new ONU newly accessing the OLT is found during a predetermined search time, adding the new ONU to the upstream transmission authority allocation sequence.

11. The method as set forth in claim 7, wherein the transmission of upstream data is performed if the ONU having the upstream data for transmission receives the downstream data frame designating the ONU as the upstream transmission authority allocation target ONU.

12. A method for controlling upstream data traffic transferred from an ONU (Optical Network Unit) to an OLT (Optical Line Termination) in an EPON (Ethernet Passive Optical Network) system including an ODN (Optical Distribution Network) connected to one OLT, and a plurality of ONUs connected to the ODN and also respectively coupled to a plurality of subscribers, the method comprising the steps of:
a) controlling the ONU to perform buffering on upstream transmission data;
b) controlling the ONU to receive a downstream data frame from the OLT;
c) interpreting upstream transmission authority allocation target ONU information contained in the received downstream data frame; and,
d) if the interpreted ONU information indicates information of a corresponding ONU, performing upstream transmission on the buffering data.

13. An apparatus for controlling upstream data traffic transferred from an ONU (Optical Network Unit) to an OLT (Optical Line Termination) in an EPON (Ethernet Passive Optical Network) system including an ODN (Optical Distribution Network) connected to one OLT, and a plurality of ONUs connected to the ODN and also respectively connected to a plurality of subscribers, comprising:
a traffic manager for managing upstream data traffic information transferred from the ONU to the OLT;
a controller for determining an ONU serving as an upstream transmission authority allocation target on the basis of the upstream data traffic information managed by the traffic manager;
a downstream data processor for inserting information of the ONU having been determined by the controller in a downstream data frame to be transferred from the OLT to the ONU; and,
a transmitter for broadcasting the downstream data frame having been created by the downstream data processor to the ONUs.

14. The apparatus as set forth in claim 13, further comprising:
a counter for determining whether a new ONU is coupled to the OLT for every predetermined unit time, and transmitting the determination result to the traffic manager and the controller.

15. The apparatus as set forth in claim 13, wherein the traffic manager further includes:
an entire traffic manager for managing an amount of upstream data transferred from all the ONUs connected to the OLT; and
a plurality of individual traffic managers for every ONU for managing the amount of upstream data transferred from the ONUs.

16. The apparatus as set forth in claim 15, wherein the number of traffic managers for every ONU is equal to the number of ONUs coupled to the OLT.

17. The apparatus as set forth in claim 15, wherein the controller receives upstream traffic information from the entire traffic manager and the individual traffic managers, calculates upstream traffic use efficiency for every ONU corresponding to aratio of the amount of upstream data from each ONU to the amount of upstream data transferred from the entire ONUs, and storing and managing the calculated upstream traffic use efficiency.

18. The apparatus as set forth in claim 17, wherein the controller determines an upstream transmission authority allocation sequence of the ONUs coupled to the OLT, determines a candidate ONU for upstream transmission authority allocation according to the upstream transmission authority allocation sequence, compares the upstream traffic use efficiency of the candidate ONU with predetermined reference use efficiency, determines whether the upstream traffic use efficiency of the candidate ONU is less than the predetermined reference use efficiency, and determines the candidate ONU to be an upstream transmission authority allocation target ONU when the upstream traffic use efficiency of the candidate ONU is less than the predetermined reference use efficiency.

19. The apparatus as set forth in claim 18, wherein the controller determines whether the upstream traffic use efficiency of the candidate ONU is higher than the predetermined reference use efficiency, selecting the next ONU in the upstream transmission authority allocation sequence when the upstream traffic use efficiency of the candidate ONU is higher than the predetermined reference use efficiency, and repeating the comparison step for comparing the upstream traffic use efficiency of the candidate ONU with the predetermined reference use efficiency.

20. The apparatus as set forth in claim 18, wherein the controller determines whether a new ONU accessing the OLT is found during a predetermined search time, and includes the new ONU to the upstream transmission authority allocation sequence.
